(19) United States
(12) Patent Application Publication
(10) Pub. No.: US 2026/0048682 A1
(43) Pub. Date: Feb. 19, 2026

(54) FAULT OPERATION STRATEGY FOR PARALLEL BATTERY PACKS

(71) Applicant: GM Global Technology Operations LLC, Detroit, MI (US)

(72) Inventors: Lei Hao, Troy, MI (US); Jun-mo Kang, Ann Arbor, MI (US); Shuonan Xu, Troy, MI (US); Chandra S. Namuduri, Troy, MI (US)

(21) Appl. No.: 18/808,608

(22) Filed: Aug. 19, 2024

(51) Int. Cl. B60L 58/20; B60L 50/60; H02H 7/12

(52) U.S. Cl. CPC B60L 58/20; B60L 50/66; H02H 7/1213; B60L 2210/12

(57) ABSTRACT

A vehicle includes an electrical load and an electrical system for providing power to the electrical load. The electrical system includes a converter including at least one leg, at least one inductor and a pyro switch between the at least one leg and the at least one inductor, an energy cell coupled to the converter at a first side of the converter, a propulsion cell coupled to a second side of the converter, and a processor. The processor is configured to measure a voltage at a switch of the converter, determine a switch status of the switch based on the voltage, operate the pyro switch to disable the at least one leg that includes the switch, derate a power of the converter to a percentage of a full power of the converter, and provide the derated power to the electrical load.

The subject disclosure relates to electrical systems in vehicle and, in particular, to a system and method of operating the electrical system in the event of a switch operating in a non-optimal condition within a DC-DC converter (direct current to direct current converter) of the electrical system.

An electrical system of a vehicle generally includes a DC-DC converter that transfers power between an energy source and a power source. The energy source has a higher energy density than the power source and therefore can be used to increase the range of the vehicle. The power source has higher power density than the energy source and can therefore be used to increase the performance or propulsion of the vehicle. Power is generally provided from the energy source to the converter. The converter transfers the power to a power cell and to an electrical load which can be used to drive the vehicle. A non-optimal switch in the converter is undesirable for the electrical system. Accordingly, it is desirable to provide an electrical system that can continue operation in the event of a switch within the converter operating in a non-optimal condition.

### SUMMARY

In one exemplary embodiment, a method of operating an electrical system of a vehicle is disclosed. The method includes measuring a voltage at a switch of a converter of the electrical system, the converter coupled to an energy cell at a first side of the converter and to a propulsion cell at a second side, wherein an electrical load is located at the second side of the converter, determining a switch status of the switch based on the voltage, disabling a leg of the converter that includes the switch, derating a power of the converter to a percentage of a full power of the converter, and providing the derated power to the electrical load.

In addition to one or more of the features described herein, wherein the switch is on one leg of the converter and the switch forms an open circuit, the method further includes disabling the one leg and derating the power to ⅔ of the full power of the converter.

In addition to one or more of the features described herein, wherein the switch includes a first switch on a first leg of the converter and a second switch on a second leg of the converter and both the first switch and the second switch form open circuits, the method further including disabling the first leg and the second leg and derating the power to ⅓ of the full power of the converter.

In addition to one or more of the features described herein, wherein the switch includes a first switch on a first leg of the converter, a second switch on a second leg of the converter, and a third switch on a third leg of the converter and all switches form open circuits, the method further includes disconnecting the converter from the energy cell and using the propulsion cell to provide the power to the electrical load.

In addition to one or more of the features described herein, wherein the switch closes to form a short circuit, the method further including closing another switch on the leg.

In addition to one or more of the features described herein, the method further includes one of detecting a fault at the propulsion cell and isolating the propulsion cell from the electrical system and detecting the fault at the energy cell and isolating the energy cell from the converter.

In addition to one or more of the features described herein, the method further includes opening a pyro switch between the leg and an inductor of the converter.

In another exemplary embodiment, an electrical system of a vehicle is disclosed. The electrical system includes a converter, an energy cell coupled to the converter at a first side of the converter, a propulsion cell coupled to a second side of the converter, an electrical load is located at the second side of the converter, and a processor. The processor is configured to measure a voltage at a switch of the converter, determine a switch status of the switch based on the voltage, disable a leg of the converter that includes the switch, derate a power of the converter to a percentage of a full power of the converter, and provide the derated power to the electrical load.

In addition to one or more of the features described herein, the switch is on one leg of the converter and the switch forms an open circuit and the processor is further configured to disable the one leg and derate the power to ⅔ of the full power of the converter.

In addition to one or more of the features described herein, the switch includes a first switch on a first leg of the converter and a second switch on a second leg of the converter and both the first switch and the second switch form open circuits and the processor is further configured to disable the first leg and the second leg and derate the power to ⅓ of the full power of the converter.

In addition to one or more of the features described herein, the switch includes a first switch on a first leg of the converter, a second switch on a second leg of the converter, and a third switch on a third leg of the converter and all switches form open circuits and the processor is further configured to disconnect the converter from the energy cell and using the propulsion cell to provide the power to the electrical load.

In addition to one or more of the features described herein, wherein the switch closes to form a short circuit and the processor is further configured to close another switch on the leg.

In addition to one or more of the features described herein, the processor is further configured to perform one of detecting a fault at the propulsion cell and isolate the propulsion cell from the electrical system and detecting the fault at the energy cell and isolate the energy cell from the converter.

In addition to one or more of the features described herein, the processor is further configured to open a pyro switch between the leg and an inductor of the converter.

In yet another exemplary embodiment, a vehicle is disclosed. The vehicle includes an electrical load and an electrical system for providing power to the electrical load. The electrical system includes a converter including at least one leg, at least one inductor and a pyro switch between the at least one leg and the at least one inductor, an energy cell coupled to the converter at a first side of the converter, a propulsion cell coupled to a second side of the converter, and a processor. The processor is configured to measure a voltage at a switch of the converter, determine a switch status of the switch based on the voltage, operate the pyro switch to disable the at least one leg that includes the switch, derate a power of the converter to a percentage of a full power of the converter, and provide the derated power to the electrical load.

In addition to one or more of the features described herein, the switch is on one leg of the converter and the switch forms an open circuit and the processor is further configured to disable the one leg and derate the power to ⅔ of the full power of the converter.

In addition to one or more of the features described herein, the switch includes a first switch on a first leg of the converter and a second switch on a second leg of the converter and both the first switch and the second switch form open circuits and the processor is further configured to disable the first leg and the second leg and derate the power to ⅓ of the full power of the converter.

In addition to one or more of the features described herein, the switch includes a first switch on a first leg of the converter, a second switch on a second leg of the converter, and a third switch on a third leg of the converter and all switches form open circuits and the processor is further configured to disconnect the converter from the energy cell and using the propulsion cell to provide the power to the electrical load.

In addition to one or more of the features described herein, the switch closes to form a short circuit and the processor is further configured to close another switch on the leg.

In addition to one or more of the features described herein, the processor is further configured to perform one of detecting a fault at the propulsion cell and isolate the propulsion cell from the electrical system and detecting a fault at the energy cell and isolate the energy cell from the converter.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, in accordance with an exemplary embodiment;

FIG. 2 shows an electrical system of the vehicle in an embodiment;

FIG. 3 shows the electrical system during another normal operation or propulsion operation;

FIG. 4 shows a detailed view of the electrical system, in an embodiment;

FIG. 5 shows a diagram of the electrical system with a switch creating an open circuit, in one embodiment;

FIG. 6 shows a diagram of the electrical system with a switch creating a closed circuit, in an embodiment;

FIG. 7 shows a flowchart of a method for controlling operation of the electrical system based on a fault occurring at one of the battery packs of the electrical system;

FIG. 8 is a flowchart of a method for operating the electric system when a fault occurs at the converter;

FIG. 9 shows a detection circuit for detecting a fault at a switch; and

FIG. 10 shows a detailed view of the converter in an alternative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

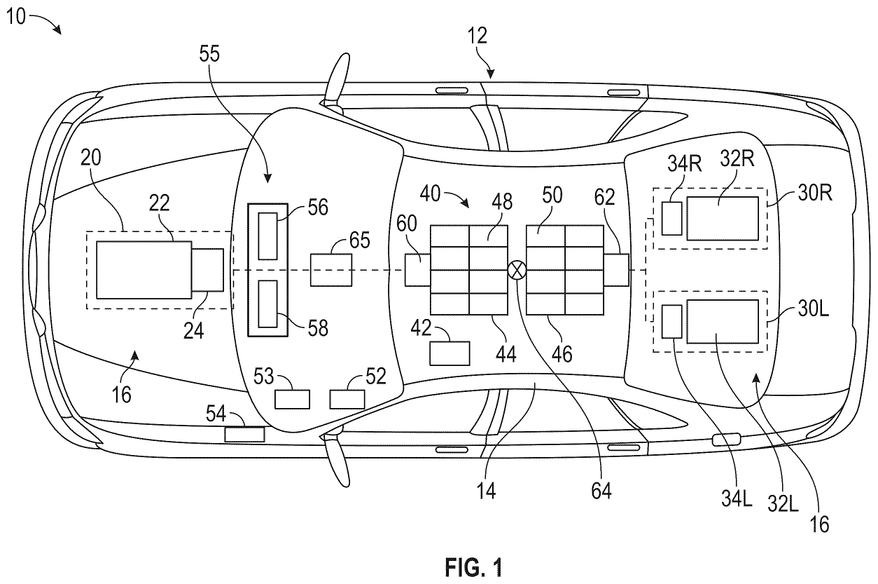

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

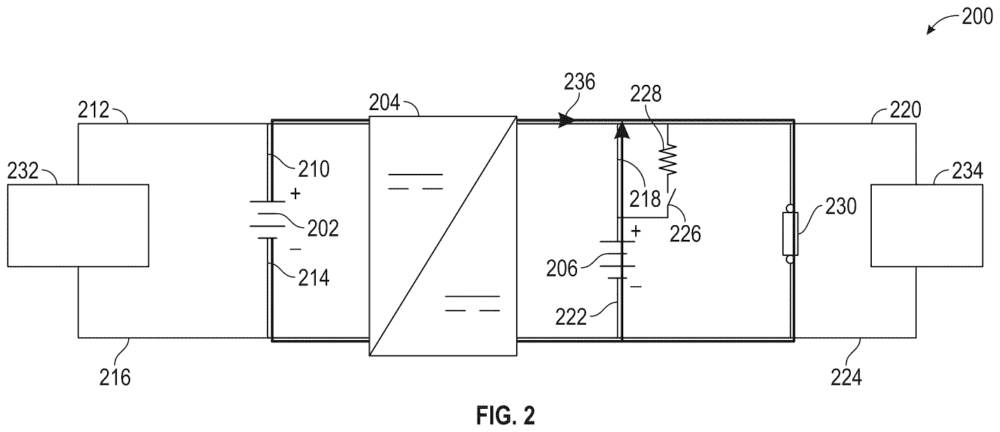

FIG. 2 shows an electrical system 200 of the vehicle in an embodiment. The electrical system 200 includes a first power source, such as energy cell 202, a converter 204 (e.g., a DC-DC converter), and a second power supply, such as propulsion cell 206. In an embodiment, the converter 204 can be a bi-directional, multi-phase DC-DC converter. In general, the energy cell 202 is a high voltage power source and the propulsion cell 206 is a low voltage power source. The energy cell 202 is located on a first side (high voltage side) of the converter 204 and the propulsion cell 206 is located on a second side (low voltage side). The propulsion cell 206 is directly connected to an electrical load 230, while the energy cell 202 is separated from the electrical load by the converter 204.

A first contactor 210 connects the energy cell 202 to a high voltage positive bus 212 and a second contactor 214 switch connects the energy cell to a high voltage negative bus 216. Similarly, a third contactor 218 connects the propulsion cell 206 to a low voltage positive bus 220 and a fourth contactor 222 connects the propulsion cell 206 to a low voltage negative bus 224. A pre-charge switch 226 and pre-charge resistor 228 are on a leg that is in parallel with the third contactor 218. An electrical load 230 is connected across the low voltage positive bus 220 and the low voltage negative bus 224.

A first detection circuit 232 is connected between the high voltage positive bus 212 and the high voltage negative bus 216 and can detect voltages across the energy cell 202. A second detection circuit 234 is connected between the low voltage positive bus 220 and the low voltage negative bus 224 and can detect voltages across the propulsion cell 206.

FIG. 2 shows the electrical system 200 during normal operation. The voltage across the energy cell 202 is converted to a low voltage by the converter 204. The low voltage can be used at the electrical load 230. During normal operation, the first contactor 210, the second contactor 214, the third contactor 218 and the fourth contactor 222 are closed, thereby both power cell and energy cell provide power to electrical load 230. This results in the current flow 236 as shown.

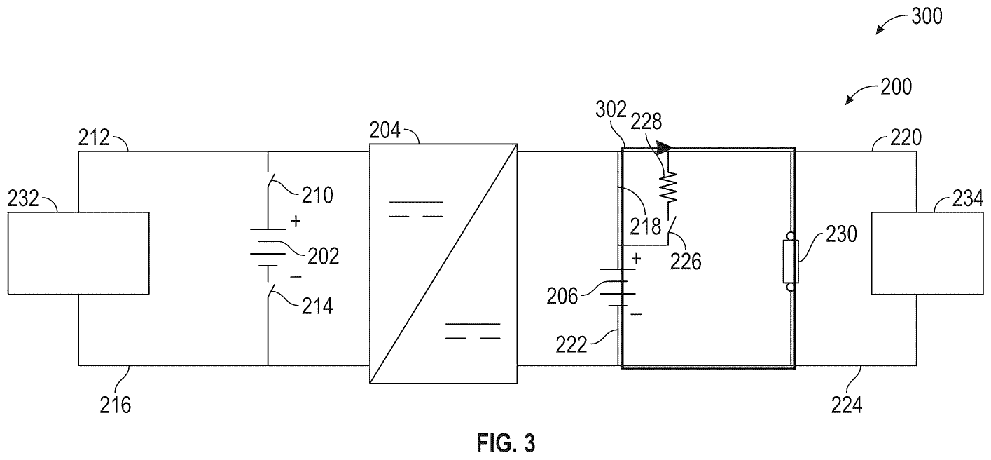

FIG. 3 shows the electrical system 200 during another normal operation or propulsion operation. The first contactor 210 and the second contactor 214 are open while the third contactor 218 and the fourth contactor 222 are closed, thereby removing the energy cell 202 from the circuit while connecting the propulsion cell 206 to the circuit. This results in the current flow 302 as shown.

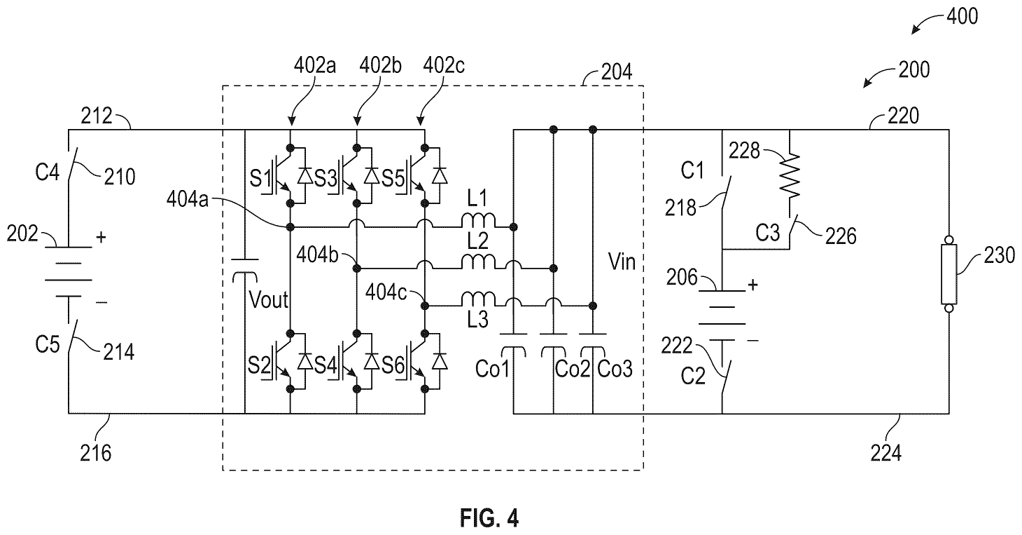

FIG. 4 shows a detailed view 400 of the electrical system 200, in an embodiment. The converter 204 includes a first leg 402a, a second leg 402b, and a third leg 402c. These legs extend between the high voltage positive bus 212 and the high voltage negative bus 216 and are in parallel with each other. The first leg 402a includes a first switch S1 and a second switch S2 in series. The second leg 402b includes a third switch S3 and a fourth switch S4 in series. The third leg 402c includes a fifth switch S5 and a sixth switch S6 in series. A first midpoint 404a between the first switch S1 and the second switch S2 is connected to the low voltage side via a first inductor L1. A second midpoint 404b between the third switch S3 and the fourth switch S4 is connected to the low voltage side via a second inductor L2. A third midpoint 404c between the fifth switch S5 and the sixth switch S6 is connected to the low voltage side via a third inductor L3.

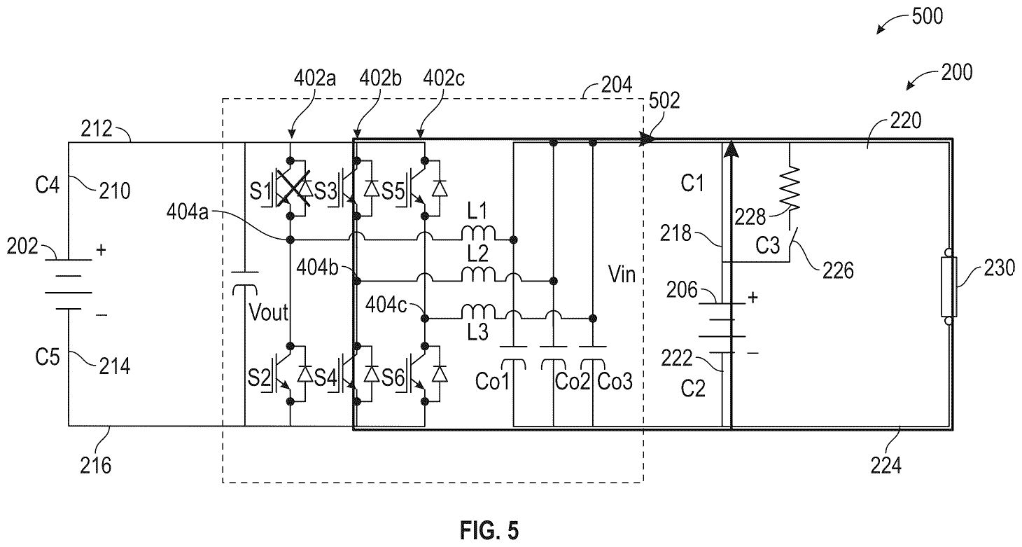

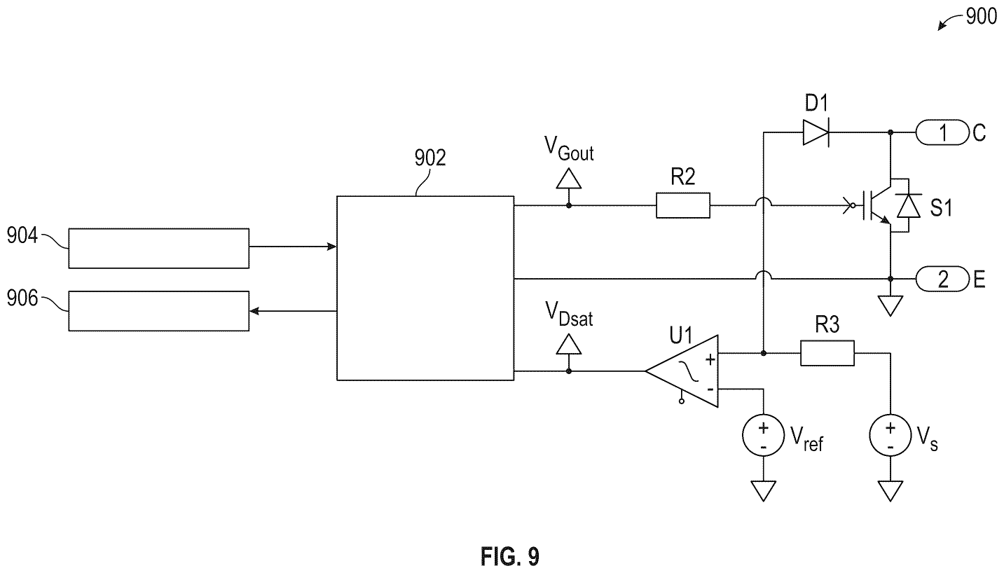

FIG. 5 shows a diagram 500 of the electrical system 200 with a switch creating an open circuit, in one embodiment. The open circuit of any switch of the converter can be diagnosed using the circuit of FIG. 9, as disclosed herein. For illustrative purposes, the open-circuit switch is the first switch S1. When the first switch S1 is diagnosed as forming an open circuit, the second switch S2 can be set to be an open state (i.e., open circuit), thereby removing the first leg 402a from the circuit and isolating the first inductor L1 from the energy cell 202. Current can still flow through both of the second leg 402b and the third leg 402c. A resulting current loop 502 is shown. Although the open switch is discussed with respect to switch S1, it is understood that any switch the operates to form an open circuit in a given leg of the converter can be remedied by opening the other switch on the given leg.

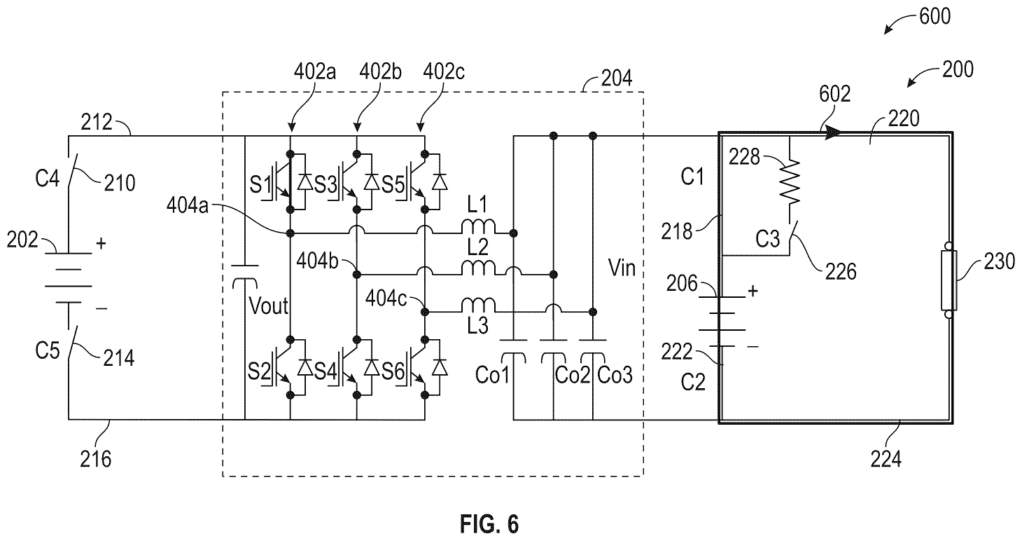

FIG. 6 shows a diagram 600 of the electrical system 200 with a switch creating a short circuit, in an embodiment. For illustrative purposes, the short-circuit switch is the first switch S1. When the first switch S1 is diagnosed as having a short, the first contactor 210 and the second contactor 214 can be opened to disable the connection between the energy cell 202 and the converter 204. As a result, current is provided by the propulsion cell 206 resulting in the current loop 602 shown in FIG. 6.

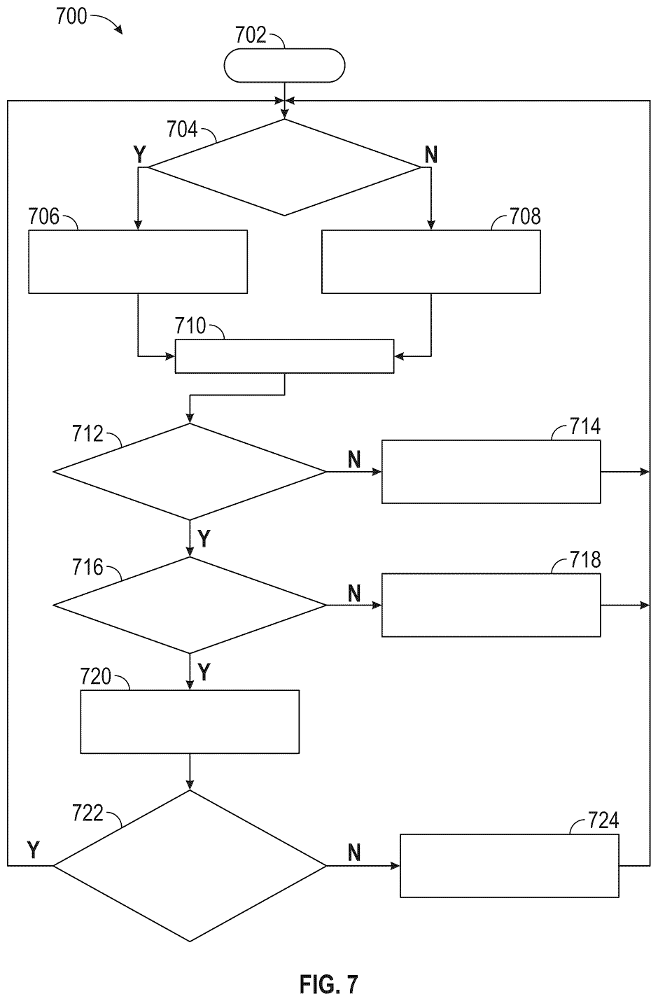

FIG. 7 shows a flowchart 700 of a method for controlling operation of the electrical system 200 based on a fault occurring at one of the battery packs of the electrical system. The method starts at box 702. In box 704, a check is made on the state of the converter 204. If the converter is disabled, the method proceeds to box 706. If the converter is not disabled, the method proceeds to box 708. In box 706, the propulsion cell is used to provide power directly to the electrical load. In box 708, the energy cell provides power to the electric load through the converter 204. From either box 706 or box 708, the method proceeds to box 710.

In box 710, the electrical system is measured to detect an isolation fault. The measurement is diagnosed at box 712. In box 712, if a non-optimal condition or fault state is not detected at the converter, the method proceeds to box 714. In box 714, normal DC-DC conversion is performed at the converter. The method then returns to box 704.

Returning to box 712, if a non-optimal condition is detected at the converter, the method proceeds to box 716. In box 716, a diagnosis is performed at the energy cell 202. If the energy cell 202 is good (optimal condition), the method proceeds to box 718. In box 718, the contactors for the propulsion cell 206 (i.e., the third contactor S3 and the fourth contactor S4) are opened. The method then returns to box 704. Returning to box 716, if the energy cell is determined to be in a fault state, the method proceeds to box 720. In box 720, the contactors of the energy cell 202 (i.e., the first contactor S1 and the second contactor S2) are opened. The method then proceeds to box 722.

In box 722, the input voltage to the converter is measured. If the input voltage is positive (Vin>0), the method returns to box 704. Otherwise, if the input voltage is zero or negative, the method proceeds to box 724. In box 724, the converter is disabled. The method then returns to box 704.

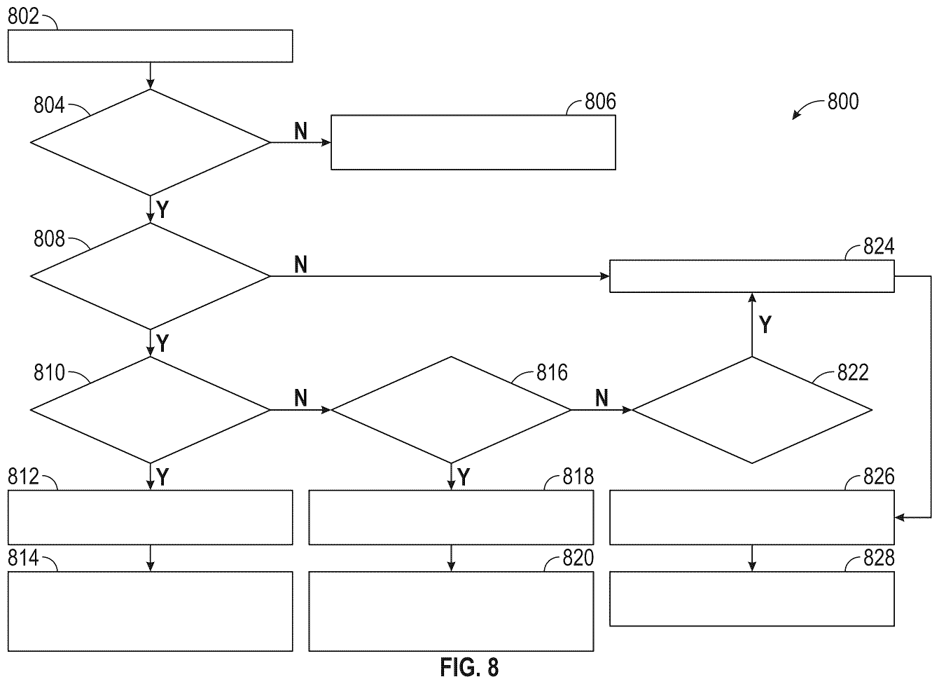

FIG. 8 is a flowchart 800 of a method for operating the electric system when a fault occurs at the converter 204. The method begins at box 802, in which a status of a switch of the converter (i.e., S1-S6) is detected or monitored. In box 804, a decision is made based on the switch state. If no switch fault is detected, the method proceeds to box 806. In box 806, normal DC-DC conversion is performed using the converter. Returning to box 804, if a fault is detected at a switch, the method proceeds to box 808.

In box 808, the type of switch fault is determined for the non-optimal switch. If the switch fault is open (an open circuit), the method proceeds to box 810. If the switch fault is closed (short circuit), the method proceeds to box 824.

In box 810, the number of legs with open circuits is counted. If a switch on one leg is forming an open circuit (i.e., one faulted leg), the method proceeds to box 812. In box 812, the switch for the faulted leg (i.e., the leg with the open circuit) is disabled. In box 814, the DC-DC power of the converter is derated to a power of ⅔ of the full power of the converter. The derating is performed by limiting the target output current of the converter.

Returning to box 810, if the number of faulted legs is not equal to one, the method proceeds to box 816. In box 816, if switches on two legs are forming open circuits (i.e., two faulted legs), the method proceeds to box 818. In box 818, the switches for both faulted legs are disabled. In box 820, the DC-DC power of the converter is derated to a power of ⅓ of the full power of the converter. The derating is performed by limiting the target output current of the converter.

Returning to box 816, if the number of faulted legs is not equal to two, the method proceeds to box 822. In box 822, if switches on all three legs are forming open circuits (i.e., three faulted legs), the method proceeds to box 824. In box 824, the contactors to the energy cell 202 (i.e., first contactor 210 and second contactor 214) are opened. In box 826, the switches (i.e., switches S1-S6) of the converter are disabled. In box 828, the propulsion cell is used to provide power to the electrical load and/or for driving.

FIG. 9 shows a detection circuit 900 for detecting a fault at a switch. For illustrative purposes switch S1 is shown. The detection circuit 900 includes a gate driver 902. The gate driver 902 can be a controller that includes a processor for operating fault logic to determine a state of the switch S1. The controller may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller may also include a non-transitory computer-readable medium that stores instructions which are processed by one or more processors of the controller to implement processes detailed herein.

A control input 904 is provided as input to the gate driver 902. The gate drive outputs a fault state or switch status 906. The control input 904 is used to interrogate the switch and the switch status 906 is output as a result of the interrogation. The gate driver 902 provides a signal (VGout) to a gate of switch S1 and receives a saturation state (VDsat) of the switch S1. VGout can be LOW or HIGH and VDsat can be LOW or HIGH. The gate driver 902 performs a fault logic operation as shown in Table 1:

TABLE 1

| VG_OUT | VD_SAT | Switch Status |
|---|---|---|
| LOW | LOW | FAULT (SHORT) |
| LOW | HIGH | NORMAL |
| HIGH | LOW | FAULT (OPEN) |
| HIGH | HIGH | NORMAL |

and outputs the switch status based on the results of the fault logic operation.

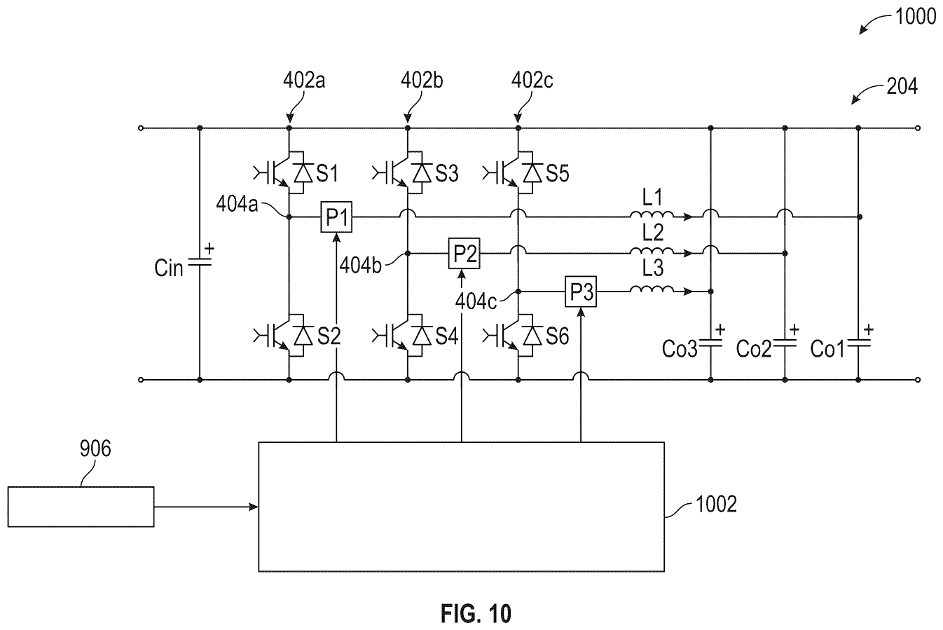

FIG. 10 shows a detailed view 1000 of the converter 204 in an alternative embodiment. A first pyro switch P1 is located between the first midpoint 404a and the first inductor L1. A second pyro switch P2 is located between the second midpoint 404b and the second inductor L2. A third pyro switch P3 is located between the third midpoint 404c and the third inductor L3. Each of the first pyro switch P1, second pyro switch P2 and third pyro switch P3 are connected to a pyro switch control signal generator 1002. The pyro switch control signal generator 1002 can receive a switch status 906 for each of the switches S1-S6 and control a respective pyro switch in response to the switch status. In particular, if the switch status on any switch is non-optimal (a fault state), the corresponding pyro switch can be triggered to disconnect a corresponding leg from the circuit and to allow the healthy legs to continue to transfer power (within their capacity).

Table 2 shows a possible fault modes or operation, actions taken for each fault mode and an available power for the fault mode.

TABLE 2

| | | Available |
|---|---|---|
| Fault Modes | Action | Power |
| One switch open in DC- | Derate DC-DC power to ⅔ | 0.67*P_{DCDC} + |
| DC converter (i.e., S1 | of its full power, via limiting | Pₚᵣₒₚ |
| open) | the target DCDC output | |
| | current | |
| Two switches (in two | Derate DC-DC power to ⅓ | 0.33*P_{DCDC} + |
| different legs) open in | of its full power, via limiting | Pₚᵣₒₚ |
| DC-DC converter (i.e., | the target DCDC output | |
| S1 and S3 open) | current | |
| Whole DCDC forms | Open C4 and C5, only use | Pₚᵣₒₚ |
| open circuits (all three | propulsion cells for driving | |
| legs are open) | | |
| Propulsion sub-pack | Open C1 and C2, only use | P_{DCDC} |
| fault; loss of isolation; | energy cells for driving | |
| or other faults that | | |
| require opening the | | |
| contactors | | |
| Energy sub-pack fault; | Open C4 and C5, only use | Pₚᵣₒₚ |
| loss of isolation; or | propulsion cells for driving | |
| other faults that require | | |
| opening the contactor | | |

If a switch in one leg of the converter forms an open circuit, the power is derated to ⅔ of its full power. The available power is therefore ⅔ of the power of the converter (P_{DCDC}) plus the power provided by the propulsion cell 206 (Pₚᵣₒₚ). If switches in any two (separate) legs of the converter form open circuits, the power is derated to ⅓ of its full power. The available power is therefore ⅓ of the power of the converter plus the power provided by the propulsion cell 206. If the whole converter forms an open circuit (i.e., switches on all three legs of the converter form open circuits), the first contactor 210 and the second contactor 214 are opened and only the propulsion cell 206 is used for driving. The available power is the power of the propulsion cell 206 (Pₚᵣₒₚ).

If the propulsion cell 206 has a fault, the third contactor 218 and the fourth contactor 222 are opened. The available power is the power of the converter (P_{DCDC}). If the energy cell 202 fails, the first contactor 210 and the second contactor 214 are opened and only the propulsion cell 206 is used for driving. The available power is the power of the propulsion cell 206 (Pₚᵣₒₚ).

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating an electrical system of a vehicle, comprising:
measuring a voltage at a switch of a converter of the electrical system, the converter coupled to an energy cell at a first side of the converter and to a propulsion cell at a second side, wherein an electrical load is located at the second side of the converter;
determining a switch status of the switch based on the voltage;
disabling a leg of the converter that includes the switch;
derating a power of the converter to a percentage of a full power of the converter; and
providing the derated power to the electrical load.

2. The method of claim 1, wherein the switch is on one leg of the converter and the switch forms an open circuit, further comprising disabling the one leg and derating the power to ⅔ of the full power of the converter.

3. The method of claim 1, wherein the switch includes a first switch on a first leg of the converter and a second switch on a second leg of the converter and both the first switch and the second switch form open circuits, further comprising disabling the first leg and the second leg and derating the power to ⅓ of the full power of the converter.

4. The method of claim 1, wherein the switch includes a first switch on a first leg of the converter, a second switch on a second leg of the converter, and a third switch on a third leg of the converter and all switches form open circuits, further comprising disconnecting the converter from the energy cell and using the propulsion cell to provide the power to the electrical load.

5. The method of claim 1, wherein the switch closes form a short circuit, further comprising closing another switch on the leg.

6. The method of claim 1, further comprising one of: (i) detecting a fault at the propulsion cell and isolating the propulsion cell from the electrical system; and (ii) detecting the fault at the energy cell and isolating the energy cell from the converter.

7. The method of claim 1, further comprising opening a pyro switch between the leg and an inductor of the converter.

8. An electrical system of a vehicle, comprising:
a converter;
an energy cell coupled to the converter at a first side of the converter;
a propulsion cell coupled to a second side of the converter;
an electrical load is located at the second side of the converter; and
a processor configured to:
measure a voltage at a switch of the converter;
determine a switch status of the switch based on the voltage;
disable a leg of the converter that includes the switch;
derate a power of the converter to a percentage of a full power of the converter; and
provide the derated power to the electrical load.

9. The electrical system of claim 8, wherein the switch is on one leg of the converter and the switch forms an open circuit and the processor is further configured to disable the one leg and derate the power to ⅔ of the full power of the converter.

10. The electrical system of claim 8, wherein the switch includes a first switch on a first leg of the converter and a second switch on a second leg of the converter and both the first switch and the second switch form open circuits and the processor is further configured to disable the first leg and the second leg and derate the power to ⅓ of the full power of the converter.

11. The electrical system of claim 8, wherein the switch includes a first switch on a first leg of the converter, a second switch on a second leg of the converter, and a third switch on a third leg of the converter and all switches form open circuits and the processor is further configured to disconnect the converter from the energy cell and using the propulsion cell to provide the power to the electrical load.

12. The electrical system of claim 8, wherein the switch closes to form a short circuit and the processor is further configured to close another switch on the leg.

13. The electrical system of claim 8, wherein the processor is further configured to perform one of: (i) detecting a fault at the propulsion cell and isolate the propulsion cell from the electrical system; and (ii) detecting the fault at the energy cell and isolate the energy cell from the converter.

14. The electrical system of claim 8, wherein the processor is further configured to open a pyro switch between the leg and an inductor of the converter.

15. A vehicle, comprising:
an electrical load;
an electrical system for providing power to the electrical load, the electrical system including a converter including at least one leg, at least one inductor and a pyro switch between the at least one leg and the at least one inductor, an energy cell coupled to the converter at a first side of the converter, and a propulsion cell coupled to a second side of the converter;
a processor configured to:
measure a voltage at a switch of the converter;
determine a switch status of the switch based on the voltage;
operate the pyro switch to disable the at least one leg that includes the switch;
derate a power of the converter to a percentage of a full power of the converter; and
provide the derated power to the electrical load.

16. The vehicle of claim 15, wherein the switch is on one leg of the converter and the switch forms an open circuit and the processor is further configured to disable the one leg and derate the power to ⅔ of the full power of the converter.

17. The vehicle of claim 15, wherein the switch includes a first switch on a first leg of the converter and a second switch on a second leg of the converter and both the first switch and the second switch form open circuits and the processor is further configured to disable the first leg and the second leg and derate the power to ⅓ of the full power of the converter.

18. The vehicle of claim 15, wherein the switch includes a first switch on a first leg of the converter, a second switch on a second leg of the converter, and a third switch on a third leg of the converter and all switches form open circuits and the processor is further configured to disconnect the converter from the energy cell and using the propulsion cell to provide the power to the electrical load.

19. The vehicle of claim 15, wherein the switch closes to form a short circuit and the processor is further configured to close another switch on the leg.

20. The vehicle of claim 15, wherein the processor is further configured to perform one of: (i) detect a fault at the propulsion cell and isolate the propulsion cell from the electrical system; and (ii) detect a fault at the energy cell and isolate the energy cell from the converter.
